(19) United States
(12) Patent Application Publication
(10) Pub. No.: US 2020/0082964 A1
(43) Pub. Date: Mar. 12, 2020

(54) COMPOSITE MAGNETIC BODY, SUBSTRATE INCLUDING COMPOSITE MAGNETIC BODY, AND HIGH-FREQUENCY ELECTRONIC COMPONENT INCLUDING SAME

(71) Applicant: TDK CORPORATION, Tokyo (JP)

(72) Inventors: Takeshi SAKAMOTO, Tokyo (JP); Yoshihiro SHINKAI, Tokyo (JP); Yu YONEZAWA, Tokyo (JP); Hideharu MORO, Tokyo (JP); Kensuke ARA, Tokyo (JP); Tohru OIKAWA, Tokyo (JP); Isao KANADA, Tokyo (JP); Kenji HORINO, Tokyo (JP); Kyung-Ku CHOI, Tokyo (JP)

(73) Assignee: TDK CORPORATION, Tokyo (JP)

(21) Appl. No.: 16/494,791

(22) PCT Filed: Mar. 30, 2018
(86) PCT No.: PCT/JP2018/013771

§ 371 Date: Sep. 17, 2019

(30) Foreign Application Priority Data
Mar. 31, 2017 (JP) 2017-071727

(51) Int. Cl. H01F 1/33; H01F 1/24; H01F 27/255; H01F 17/04; H01F 17/00

(52) U.S. Cl. CPC H01F 1/33; H01F 1/24; H01F 17/0013; H01F 17/04; H01F 27/255

(57) ABSTRACT

A composite magnetic body with high permeability and low magnetic loss in a high-frequency region of a gigahertz band; and a high-frequency electronic component using the same, the electronic component being compact and having low-insertion loss. This composite magnetic body has a high permeability and a low magnetic loss especially in a high-frequency region of a gigahertz band, and is provided with: a plurality of magnetic nanowires 361-363 aligned so as not to cross each other; and insulators 365-367 that electrically insulate the plurality of magnetic nanowires 361-363.

### FIELD OF THE INVENTION

The present invention relates to a composite magnetic body, a substrate including the composite magnetic body, and a high-frequency electronic component including the same.

### RELATED ART

In accordance with the increasing demand for downsizing, thinning, or cost reduction of wireless communication devices, high-frequency electronic components mounted thereon are also increasingly demanded to be downsized, thinned, or reduced in cost.

In recent years, a frequency band used for high-frequency electronic components mounted on a wireless communication device, such as a mobile phone and a wireless LAN communication device, reaches a gigahertz hand, for example, 2.4 GHz band for a wireless LAN. Examples of the high-frequency electronic components used in a gigahertz band include inductors including coils, antennas for wireless communication devices including inductors, and filters for high-frequency noise including inductors and capacitors. These high-frequency electronic components are also increasingly demanded to be downsized, thinned, or reduced in cost.

In particular, a plurality of high-frequency electronic components may be housed in a small space inside the wireless communication device, and a high-performance high-frequency electronic component having characteristics, such as high inductance, low insertion loss, high capacitance, and high electromagnetic shielding performance, is demanded.

For example, however, when a high-frequency electronic component including an inductor is miniaturized and reduced in height, the coil cannot help having a small diameter, and it is thereby difficult to improve the performance of the high-frequency electronic component due to reduction in Q value and inductance value. In these high-frequency electronic components, it is thereby necessary to use a magnetic material having a high permeability and a low magnetic loss as a magnetic core material of the coil.

As a composite magnetic material having a high permeability and a low magnetic loss in a high-frequency region of gigahertz band, Patent Document 1 discloses a composite magnetic material in which a magnetic oxide whose main phase is hexagonal ferrite is dispersed in a resin. The composite magnetic material of Patent Document 1 contains a magnetic oxide having a high electrical resistance and can thereby reduce eddy current loss. Thus, the magnetic loss coefficient tan δ/μ at 2 GHz is as small as 0.01, and the magnetic loss coefficient tan δ/μ in the gigahertz band can be reduced. However, the real part of the complex permeability μ′ at 2 GHz is as small as 1.4, and the real part of the complex permeability μ′ in the gigahertz band cannot be increased. That is, high permeability and low magnetic loss are incompatible in the composite magnetic material of Patent Document 1.

Patent Document 2 discloses a magnetic composite material in which magnetic metal particles having a needle shape with an aspect ratio (long axis length/short axis length) of 1.5 to 20 are dispersed in a dielectric material. In the magnetic composite material of Patent Document 2, in a sample whose loss tangent (tan δ) at 3 GHz is as small as 0.014, the permeability μ′ is as small as 1.37, and the permeability μ′ in the gigahertz band cannot be increased. On the other hand, in a sample whose permeability is as large as 1.98, the loss tangent (tan δ) is as large as 0.096, and the loss tangent (tan δ) in the gigahertz band cannot be reduced. That is, high permeability and low magnetic loss are incompatible in the magnetic composite material of Patent Document 2. This is because, in Patent Document 2, magnetic metal particles are dispersed in a dielectric material, such as polyethylene, and are press-molded, so that the ratio of the magnetic particles is as low as 30%, and the magnetic metal particles cannot sufficiently be insulated from each other.

### PRIOR ART

### Patent Document

Patent document 1: JP2010238748 (A)

Patent document 2: JP2014116332 (A)

### SUMMARY OF THE INVENTION

### Problem to be Solved by the Invention

The present invention has been made in view of the above problems. It is an object of the invention to provide a composite magnetic body having high permeability and low magnetic loss in a high-frequency region of gigahertz band and a small high-frequency electronic component with low insertion loss using the composite magnetic body.

### Means for Solving the Problem

As a result of intensive studies on composite magnetic bodies with high permeability and low magnetic loss in the high-frequency region of gigahertz band, the present inventors have found that a composite magnetic body having a higher permeability and a lower magnetic loss than before can be obtained by including magnetic nanowires aligned so as not to intersect each other in the composite magnetic body, and the present invention has been completed. The present inventors have also found that a high-frequency electronic component having a smaller size and a lower insertion loss than before can be obtained by including the composite magnetic body or a magnetic substrate containing the composite magnetic body in the high-frequency electronic component, and the present invention has been completed.

That is, a composite magnetic body of the present invention includes: magnetic nanowires aligned so as not to intersect each other; and an insulator for electrically insulating the magnetic nanowires.

The composite magnetic body according to the present embodiment can have high permeability and low magnetic loss particularly in the high-frequency region of gigahertz band among the high-frequency regions of megahertz band and gigahertz band. Although the mechanism of action by which such an effect is exerted has not been clarified yet, the following mechanism of action can be considered.

That is, in the composite magnetic body according to the present invention, since the magnetic nanowires are aligned so as not to intersect each other, the volume ratio of the magnetic nanowires in the composite magnetic body can easily be increased, and the permeability of the composite magnetic body in the gigahertz band can be increased. In addition, since the magnetic nanowires are electrically insulated by the insulator, the eddy current loss can be reduced, and the magnetic loss in the gigahertz band can be reduced.

Preferably, the magnetic nanowires contain at least one metal of Fe, Co and Ni.

Preferably, a magnetic substrate includes the composite magnetic body.

Further, the high-frequency electronic component according to the present invention includes the composite magnetic body or the magnetic substrate containing the composite magnetic body. In this structure, the deterioration of the characteristics due to the inductor loss is small, and the insertion loss can be reduced particularly in the gigahertz band. Accordingly, it is possible to provide a small and thin high-frequency electronic component with low insertion loss, particularly in the high-frequency region of the gigahertz band, among the high-frequency regions of the megahertz band and the gigahertz band.

Preferably, the composite magnetic body is contained in a magnetic core. In this structure, the insertion loss can be effectively reduced particularly in the gigahertz band.

Preferably, the magnetic core includes a magnetic central leg passing through a coil, and the magnetic nanowires contained in the magnetic central leg are aligned substantially perpendicularly to a winding axis of the coil. In this structure, the magnetic flux passing through the magnetic central leg intersects the magnetic nanowires so as to be substantially orthogonal to their magnetization easy direction (longitudinal direction of the magnetic nanowires). Thus, the eddy current loss particularly in the gigahertz band is reduced, the magnetic loss is reduced, and the insertion loss of the high-frequency electronic component can be reduced.

Preferably, the substrate includes at least one of a magnetic upper substrate disposed above the coil and a magnetic lower substrate disposed below the coil, and the magnetic nanowires contained in at least one of the magnetic upper substrate and the magnetic lower substrate are aligned substantially in parallel to the winding axis of the coil, in this structure, the magnetic flux passing through at least one of the magnetic upper substrate and the magnetic lower substrate intersects the magnetic nanowires so as to be substantially orthogonal to their magnetization easy direction (longitudinal direction of the magnetic nanowires). Thus, the eddy current loss particularly in the gigahertz band is reduced, the magnetic loss is reduced, and the insertion loss of the high-frequency electronic component can be reduced.

Preferably, the magnetic core includes a magnetic outer leg disposed at a periphery of the coil, and the magnetic nanowires contained in the magnetic outer leg are aligned substantially perpendicularly to the winding axis of the coil. In this structure, the magnetic flux passing through the magnetic outer leg intersects the magnetic nanowires so as to be substantially orthogonal to their magnetization easy direction (longitudinal direction of the magnetic nanowires). Thus, the eddy current loss particularly in the gigahertz band is reduced, the magnetic loss is reduced, and the insertion loss of the high-frequency electronic component can further be reduced.

### BRIEF DESCRIPTION OF THE DRAWINGS

FIG. 1 is a perspective view showing a configuration of a high-frequency electronic component having a composite magnetic body according to an embodiment of the present invention.

FIG. 2 is a cross-sectional view taken along line II-II of the high-frequency electronic component shown in FIG. 1.

FIG. 3 is a circuit diagram showing a circuit configuration of the high-frequency electronic component shown in FIG. 1.

FIG. 4 is a partially enlarged view of the cross-sectional view shown in FIG. 2.

FIG. 5 is a perspective view showing a configuration of a high-frequency electronic component having a composite magnetic body according to another embodiment of the present invention.

### EMBODIMENTS FOR CARRYING OUT THE INVENTION

Hereinafter, the present invention is described based on embodiments shown in the figures.

### First Embodiment

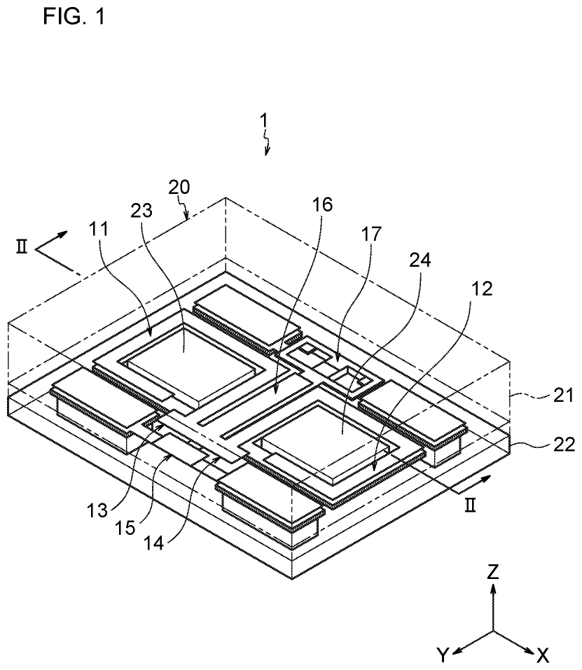

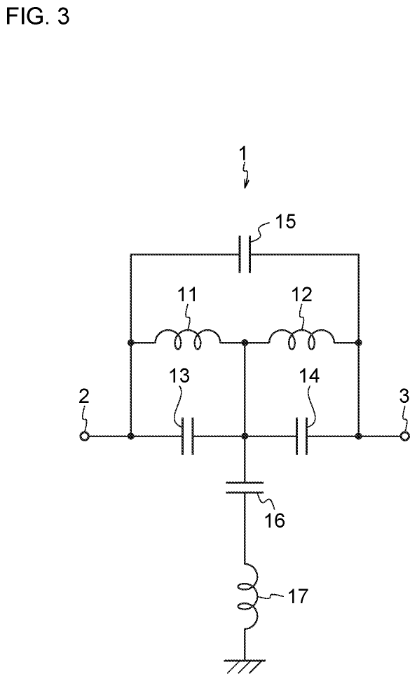

A high-frequency electronic component 1 shown in FIG. 1 is used for wireless communication devices, such as mobile phones and wireless LAN communication devices. The high-frequency electronic component 1 includes inductors 11, 12, and 17, capacitors 13 to 16, magnetic central legs 23 and 24, a magnetic upper substrate 21, and a magnetic lower substrate 22. The high-frequency electronic component 1 functions as a low pass filter as shown in FIG. 3. As shown in FIG. 1, each part of the high-frequency electronic component 1 is formed to be line-symmetrical to a symmetry axis parallel to the longitudinal direction (Y-axis direction) of the capacitor 16.

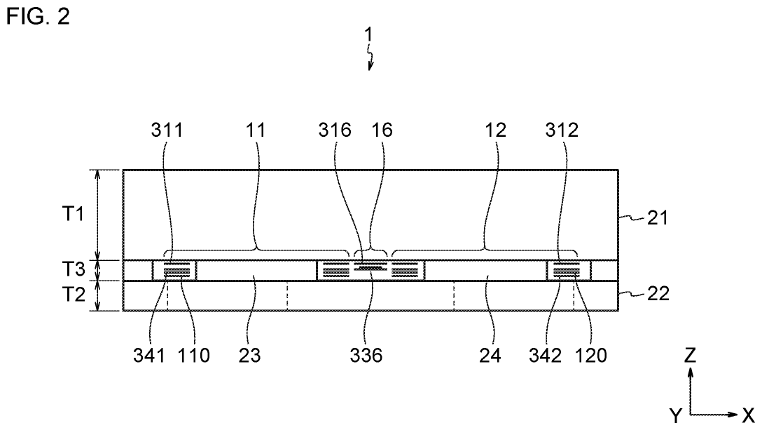

The inductors 11, 12, and 17 and the capacitors 13 to 16 are formed by forming a multilayer substrate consisting of a ground layer, an insulating layer, and a conductor layer into the shape as shown in FIG. 1. For more detail, as shown in FIG. 1 and FIG. 2, the inductor 11 includes an insulating layer 341 and consists of a coil portion 110 formed by laminating a plurality of square ring-shaped conductor layers 311 wound counterclockwise and connecting them in a coil shape. The inductor 12 includes an insulating layer 342 and consists of a coil portion 120 formed by laminating a plurality of square ring-shaped conductor layers 312 wound clockwise and connecting them in a coil shape.

As shown in FIG. 1, one end of the square ring-shaped conductor layer constituting the inductor 11 is connected with one end of the square conductor layer constituting the capacitor 13. One end of the square ring-shaped conductor layer constituting the inductor 12 is connected with one end of the square conductor layer constituting the capacitor 14. The other ends of the capacitors 13 and 14 are connected and integrated with each other, and one end of a rectangular conductor layer constituting the capacitor 16 is connected with an intermediate part in the X-axis direction of the integrated conductor layer. The other end of the capacitor 16 is connected with an inductor 17 having a square ring-shaped conductor layer, and a part of the inductor 17 is connected with the ground layer. As shown in FIG. 2, the capacitor 16 is formed by alternately laminating a plurality of insulating layers 336 and conductor layers 316. The capacitors 13 to 15 shown in FIG. 1 also have a similar structure to that of the capacitor 16 shown in FIG. 2.

The magnetic central legs 23 and 24 are magnetic cores (cores) having the same shape and function to increase the inductance of the inductors 11 and 12. The magnetic central leg 23 is inserted into the coil portion 110. The magnetic central leg 24 is inserted into the coil portion 120. The magnetic lower substrate 22 constitutes the bottom of the high-frequency electronic component 1. The magnetic upper substrate 21 constitutes the top of the high-frequency electronic component 1.

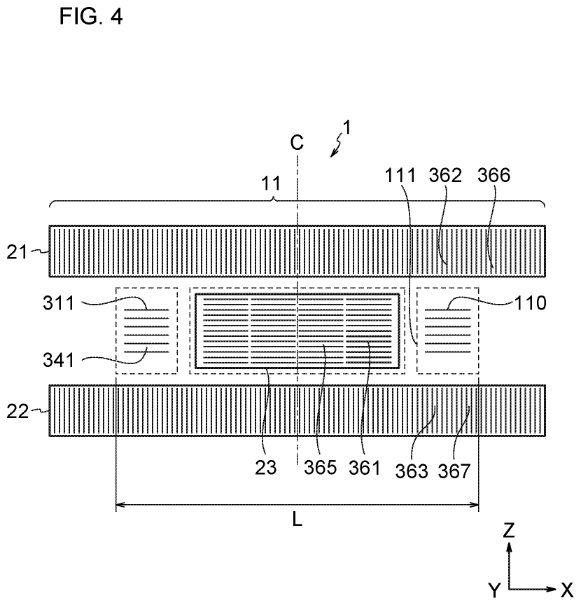

The magnetic upper substrate 21 and the magnetic lower substrate 22 are magnetic substrates and function to increase the inductance of the inductors 11, 12, and 17. As shown in FIG. 2, the magnetic upper substrate 21 and the magnetic lower substrate 22 are arranged above and below the coils 11 and 12 facing each other so as to sandwich the inductors 11, 12, and 17 and the capacitors 13 to 16. The thickness T1 in the Z-axis direction of the magnetic upper substrate 21 (the winding axis of the inductors 11 and 12) is preferably 100 nm to 1 cm, more preferably 10 to 1000 μm, and particularly preferably 50 to 500 μm. The thickness T1 may be determined according to the length of a magnetic nanowire 362 mentioned below and contained in the magnetic upper substrate 21. The thickness T2 in the Z-axis direction of the magnetic lower substrate 22 may be the same as the thickness T1 in the Z-axis direction of the magnetic upper substrate 21 as shown in FIG. 4 or may be different from the thickness T1 in the Z-axis direction of the magnetic upper substrate 21 as shown in FIG. 2. The thickness T3 in the Z-axis direction of the magnetic central leg 23 may be the same as or different from the thickness T1 in the Z-axis direction of the magnetic upper substrate 21.

As shown in FIG. 3, the input-side terminal of the capacitor 15 is connected with the input terminal 2, and the output-side terminal is connected with the output terminal 3. The inductors 11 and 12 connected in series and the capacitors 13 and 14 connected in series are connected in parallel in the capacitor 15. The output-side terminal of the capacitor 13 is connected with the output-side terminal of the inductor 11, the input-side terminal of the inductor 12, and the input-side terminal of the capacitor 16 as well as the input-side terminal of the capacitor 14. The inductor 17 is interposed between the output-side terminal of the capacitor 16 and the ground.

In the present embodiment, the magnetic central legs 23 and 24 include a composite magnetic body. The magnetic central leg 23 formed by the composite magnetic body includes linear magnetic nanowires 361 aligned so as not to intersect each other and an insulator 365 for electrically insulating the magnetic nanowires 361 from each other. As shown in FIG. 4, the magnetic nanowires 361 are aligned substantially perpendicularly to the winding axis (winding axis c) of the inductor 11. That is, the magnetic nanowires 361 are aligned substantially perpendicularly to the direction of the magnetic flux passing through the magnetic central leg 23 in the Z-axis direction. The direction substantially perpendicular to the winding axis of the inductors 11 and 12 corresponds to a direction substantially parallel to the winding direction of the coil portions 110 and 120 or a direction substantially parallel to the XY plane including the coil portions 110 and 120.

Although not illustrated, the magnetic central leg 24 formed by a composite magnetic body also includes linear magnetic nanowires 361 aligned so as not to intersect each other and an insulator 365 for electrically insulating the magnetic nanowires 361 from each other. As shown in FIG. 4, the magnetic nanowires 361 contained in the magnetic central leg 24 are aligned substantially perpendicularly to the winding axis (winding axis c) of the inductor 12. That is, the magnetic nanowires 361 are aligned substantially perpendicularly to the direction of the magnetic flux passing through the magnetic central leg 24 in the Z-axis direction.

The magnetic nanowires 361 contain at least one metal of Fe, Co, and Ni. More specifically, the magnetic nanowires 361 contain a single metal of Fe, Co, Ni, etc. and an alloy of these metals, such as FeCo alloy, FeNi alloy, CoNi alloy, and FeCoNi alloy. In addition, the magnetic nanowires 361 may contain a FeSi alloy or FeSiCr alloy in which other elements are contained in the above-described metal or alloy. In addition, the magnetic nanowires 361 may contain optional additional elements or unavoidable impurities, such as Cr, Mo, Mn, Cu, Sn, Zn, Al, P, B, and V. The magnetic nanowires 361 made of these metals or alloy's exhibit soft magnetism.

The volume ratio of the magnetic nanowires 361 in the composite magnetic body is preferably 45% or more and 90% or less. When the volume ratio is within the above range, it is possible to prevent the decrease of the real part of the permeability μ′ of the composite magnetic body due to too small volume ratio and to prevent the decrease in insulation between the magnetic nanowires 361 due to too large volume ratio.

Preferably, the magnetic nanowire 361 have a diameter of 5 nm or more and 500 nm or less. When the magnetic nanowire 361 has a diameter in the above range, it is possible to prevent the damage caused by the insufficient strength of the magnetic nanowire 361 due to too small diameter and also prevent the increase in magnetic loss tan δ/μ of the composite magnetic body due to too large diameter.

The length in the longitudinal direction of the magnetic nanowires 361 is not particularly limited, but it is considered that about 1 cm is the upper limit of the length due to the limitation of the method of manufacturing the magnetic wires 361. This is because in the manufacturing method described below, the magnetic nanowires 361 are electrodeposited in holes formed in the insulator 365, and the upper limit of the length of the holes is about 1 cm.

When the magnetic nanowires 361 are formed, the aspect ratio needs to be large. This is because the magnetic loss tan δ/μ of the composite magnetic body can be reduced in the gigahertz band by increasing the shape magnetic anisotropy of the magnetic nanowires 361.

As analyzed by the present inventors, the lower limit of the aspect ratio of the magnetic nanowires 361 is preferably 4, more preferably 20, and particularly preferably 100. The upper limit of the aspect ratio of the magnetic nanowires 361 is 2×10⁶, which corresponds to, for example, the magnetic nanowire 361 whose diameter is 5 nm and whose length is 1 cm.

As analyzed by the present inventors, the ratio d/D of the distance d and the diameter D of the magnetic nanowires 361 is preferably 0.1 to 1, more preferably 0.2 to 0.8, and particularly preferably 0.3 to 0.5.

In the present embodiment, since the magnetic nanowires 361 have a high aspect ratio, unlike Patent Document 2, a forming step for uniformly mixing magnetic metal particles and a resin is not carried out. This is because, for a uniform mixture of a resin and magnetic metal particles, the magnetic metal particles must be particles having a spherical shape or a semi-spherical shape or needle-like particles having a low aspect ratio. While it is practically difficult for the magnetic particles to have a volume ratio of 45% or more by the method of mixing the magnetic metal particles and the resin as shown in Patent Document 2, the present embodiment does not employ such a method and can easily increase the volume ratio of the magnetic nanowires 361 in the composite magnetic body.

The material of the insulator 365 is preferably an oxide or a resin. Examples of the oxide include an Al oxide, a Si oxide, a Cr oxide, a Ta oxide, and an Nb oxide. In particular, the Al oxide is preferably a porous anodic oxide formed by anodic oxidation of Al. This is because this type of porous anodic oxide self-organizingly forms a periodic porous Al oxide having periodic wire-like cavities with nano-level diameter.

Examples of the resin include polystyrene, polybutadiene, polyethylene oxide, polyethylene oxide methyl ether, polyacrylate, polymethacrylic acid ester, polyisoprene, poly N isopropylacrylamide, polybutylmethacrylic acid, polyvinylpyridine, polyferrocenyldimethylsilane, polyferrocenylethylmethylsilane, polydimethylsilane, polyethylene propylene, polyethylene, polytetrabutyl methacrylate, polymethylstyrene, polyhydroxystyrene, epoxy resin, acrylic resin, polyimide resin, polyimide resin, phenol resin, and silicon resin.

Preferably, these resins are combined to form a block copolymer, a two-dimensional periodic structure in which rod-like micelles are hexagonally arranged in a self organizing manner is formed, and the rod-like micelle part is thereafter removed. This forms the insulator 365 having periodic wire-like cavities with nano-level diameter. If necessary, surface treatment agents, such as a coupling agent and a dispersant, and additives, such as a heat stabilizer and a plasticizer, may be added.

In the present embodiment, the magnetic upper substrate 21 and the magnetic lower substrate 22 include a composite magnetic body. The magnetic upper substrate 21 includes linear magnetic nanowires 362 aligned so as not to intersect each other and an insulator 366 for electrically insulating the magnetic nanowires 362 from each other. The magnetic lower substrate 22 includes linear magnetic nanowires 363 aligned so as not to intersect each other and an insulator 367 for electrically insulating the magnetic nanowires 363 from each other.

As shown in FIG. 4, the magnetic nanowires 362 are aligned substantially in parallel to the winding axis of the inductor 11. That is, the magnetic nanowires 362 are aligned substantially perpendicularly to the direction of the magnetic flux passing through the magnetic upper substrate 21 in the X-axis direction. The magnetic nanowires 363 are aligned substantially in parallel to the winding axis of the inductor 11. That is, the magnetic nanowires 363 are aligned substantially perpendicularly to the direction of the magnetic flux passing through the magnetic lower substrate 22 in the X-axis direction. The configuration of the magnetic nanowires 362 and 363 is the same as that of the magnetic nanowires 361 described above.

Next, a method of manufacturing the high-frequency electronic component 1 is described. First, an insulator (e.g., the above-mentioned periodic porous Al oxide) composed of a periodic porous structure with a plurality of holes aligned so as not to intersect each other is prepared, and magnetic nanowires are electrodeposited into the holes to form a composite magnetic body. Then, the composite magnetic body is processed into predetermined shape and size to form the magnetic upper substrate 21, the magnetic lower substrate 22, and the magnetic central leg 23. Alternatively, the insulator is previously processed into predetermined shape and size, and magnetic nanowires are electrodeposited in the holes of the insulator to form a composite magnetic body (the magnetic upper substrate 21, the magnetic lower substrate 22, and the magnetic central leg 23).

A circuit pattern substrate on which the inductors 11, 12, and 17 and the capacitors 13 to 16 shown in FIG. 1 are formed is manufactured. For example, the inductor 11 is manufactured by laminating a plurality of square ring-shaped conductor layers 311 shown in FIG. 2 and connecting them in a coil shape. The inductor 12 is manufactured in a similar manner. Although detailed illustration is omitted, the inductor 17 and the capacitors 13 to 16 shown in FIG. 1 are also manufactured by laminating a plurality of conductive layers and insulating layers. Then, these are integrated to manufacture a circuit pattern substrate (see FIG. 2) in which the low-pass filter shown in FIG. 3 is formed.

Next, the circuit pattern substrate is placed on the upper surface of the magnetic lower substrate 22, and the magnetic central leg 23 is inserted into the opening 111 inside the coil portion 110 shown in FIG. 4 and is installed on the upper surface of the magnetic lower substrate 22. The magnetic central leg 24 shown in FIG. 1 is similarly installed on the upper surface of the magnetic lower substrate 22. Then, the magnetic upper substrate 21 covers the circuit pattern, and the respective parts are joined to obtain the high-frequency electronic component 1. The magnetic upper substrate 21, the magnetic lower substrate 22, the magnetic central legs 23 and 24, and the circuit pattern substrate may be bonded by an adhesive.

The composite magnetic body (magnetic upper substrate 21, magnetic lower substrate 22, and magnetic central leg 23) according to the present embodiment can have high permeability and low magnetic loss particularly in the high-frequency region of gigahertz band among the high-frequency regions of megahertz band and gigahertz band. Although the mechanism of action by which such an effect is exerted has not been clarified yet, the following mechanism of action can be considered.

That is, in the composite magnetic body according to the present embodiment, since the magnetic nanowires 361, 362, and 363 are aligned so as not to intersect each other, the volume ratio of the magnetic nanowires 361, 362, and 363 in the composite magnetic body can easily be increased, and the permeability of the composite magnetic body in the gigahertz band can be increased. In addition, since the magnetic nanowires 361, 362, and 363 are electrically insulated by the insulators 365, 366, and 367, the eddy current loss can be reduced, and the magnetic loss in the gigahertz band can be reduced.

The high-frequency electronic component 1 according to the present embodiment includes the magnetic upper substrate 21 and the magnetic lower substrate 22 containing the composite magnetic body. Thus, the deterioration of the characteristics due to the inductor loss is small, and the insertion loss can be reduced particularly in the gigahertz band. Accordingly, it is possible to provide a small and thin high-frequency electronic component with low insertion :loss, particularly in the high-frequency region of the gigahertz band, among the high-frequency regions of the megahertz band and the gigahertz band.

In the present embodiment, the composite magnetic body is contained in the magnetic central legs 23 and 24 passing through the inductors 11 and 12. Thus, the insertion loss can be effectively reduced particularly in the gigahertz band.

In the present embodiment, the magnetic nanowires 361 contained in the magnetic central legs 23 and 24 are aligned substantially perpendicularly to the winding axis of the inductors 11 and 12. Thus, the magnetic flux passing through the magnetic central legs 23 and 24 intersects the magnetic nanowires 361 so as to be substantially orthogonal to their magnetization easy direction (longitudinal direction of the magnetic nanowires 361). Thus, the eddy current loss particularly in the gigahertz band is reduced, the magnetic loss is reduced, and the insertion loss of the high-frequency electronic component 1 can be reduced.

In the present embodiment, the magnetic nanowires 362 and 363 contained in the magnetic upper substrate 21 and the magnetic lower substrate 22 are aligned substantially in parallel to the winding axis of the inductors 11 and 12. Thus, the magnetic flux passing through the magnetic upper substrate 21 and the magnetic lower substrate 22 intersects the magnetic nanowires 362 and 363 so as to be substantially orthogonal to their magnetization easy direction (longitudinal direction of the magnetic nanowire 361). Thus, the eddy current loss particularly in the gigahertz band is reduced, the magnetic loss is reduced, and the insertion loss of the high-frequency electronic component 1 can be reduced.

### Second Embodiment

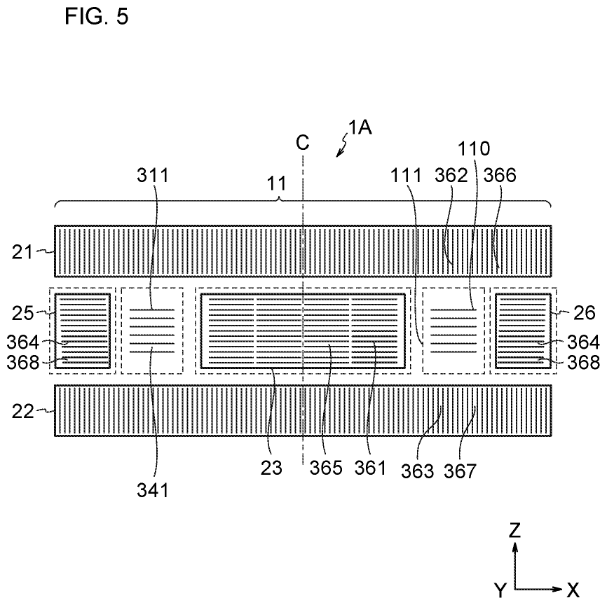

Except for the following matters, a high-frequency electronic component 1A containing a composite magnetic body according to the present embodiment shown in FIG. 5 has the same configuration and effects as those of First Embodiment described above. Common parts are not described, and the common members are given the same reference numerals in the figures. As shown in FIG. 5, the high-frequency electronic component 1A is different from the high-frequency electronic component 1 in that the high-frequency electronic component 1A further includes magnetic outer legs 25 and 26.

The magnetic outer legs 25 and 26 are magnetic cores (cores) having the same shape and function to increase the inductance of the inductors 11 and 12. The magnetic outer legs 25 and 26 are rectangular and arranged on the peripheries of the coils 11 and 12.

In the present embodiment, the magnetic outer legs 25 and 26 include a composite magnetic body. The magnetic outer legs 25 and 26 formed by the composite magnetic body include linear magnetic nanowires 364 aligned so as not to intersect each other and an insulator 368 for electrically insulating the magnetic nanowires 364 from each other. As shown in FIG. 5, the magnetic nanowires 364 are aligned substantially perpendicularly to the direction of the winding axis (winding axis c) of the inductor 11 (substantially perpendicularly to the direction of the magnetic flux passing through the region C in the Z-axis direction shown in the figure). The configuration of the magnetic nanowires 364 is similar to that of the magnetic nanowires 361 described above.

The magnetic outer legs 25 and 26 can be manufactured by processing the composite magnetic body manufactured by the method described in First Embodiment into predetermined size and shape. The high-frequency electronic component 1A can be manufactured by adding a step of installing the magnetic outer legs 25 and 26 outside the coil portion 110 on the upper surface of the magnetic lower substrate 22 shown in FIG. 5 to the above method.

The same effect as that of the above embodiment can also be obtained in the present embodiment. In addition, in the present embodiment, the magnetic nanowires 364 contained in the magnetic outer legs 25 and 26 are aligned substantially perpendicularly to the winding axis of the coils 11 and 12. Thus, the magnetic flux passing through the magnetic outer legs 25 and 26 intersects the magnetic nanowires 364 so as to be substantially orthogonal to their magnetization easy direction (longitudinal direction of the magnetic nanowires 361). Thus, the eddy current loss particularly in the gigahertz band is reduced, the magnetic loss is reduced, and the insertion loss of the high-frequency electronic component 1 can be further reduced.

The present invention is not limited to the above-described embodiments and can be variously modified within the scope of the present invention.

In the above embodiments, each of the magnetic upper substrate 21, the magnetic lower substrate 22, the magnetic central legs 23 and 24, and the magnetic outer legs 25 and 26 is entirely formed by a composite magnetic body, but each of the magnetic upper substrate 21, the magnetic lower substrate 22, the magnetic central legs 23 and 24, and the magnetic outer legs 25 and 26 may only partially be formed by a composite magnetic body.

The above embodiments describe an example in which the circuit patterns of the inductors 11, 12, and 17 and the capacitors 13 to 16 prepared in advance are installed on the upper surface of the magnetic lower substrate 22 in manufacturing the high-frequency electronic component 1, but the method of manufacturing the high-frequency electronic component 1 is not limited to this example. For example, the coil portion 110 may be formed by laminating a plurality of conductive pastes and insulating pastes on the upper surface of the magnetic lower substrate 22 and connecting them in a coil shape. The inductors 12 and 17 and the capacitors 13 to 16 may also be formed by laminating a plurality of conductive pastes and insulating pastes on the upper surface of the magnetic lower substrate 22.

In the above embodiments, the lengths of the magnetic nanowires 362 and 363 may be shortened as long as the aspect ratio does not become too small, and these may be multilayered and contained in the magnetic upper substrate 21 and the magnetic lower substrate 22. Likewise, the lengths of the magnetic nanowires 361 and 364 may be shortened as long as the aspect ratio does not become too small, and these may be contained in the magnetic central legs 23 and 24 and the magnetic outer legs 25 and 26.

In FIG. 4 and FIG. 5, the magnetic upper substrate 21 and the magnetic lower substrate 22 may have an increased thickness in the Z-axis direction to contain the magnetic nanowires 362 and 363 being multilayered. In addition, the magnetic central legs 23 and 24 and the magnetic outer legs 25 and 26 may have an increased thickness in the Z-axis direction and may further contain the magnetic nanowires 361 and 364 being multilayered.

The magnetic nanowires 361 to 364 are orderly aligned so as not to intersect each other in the examples shown in FIG. 4 and FIG. 5, but may be aligned somewhat at random as long as they do not intersect each other. Moreover, the magnetic nanowires 361 to 364 have the substantially same length in the examples shown in FIG. 4 and FIG. 5, but may have slightly different lengths.

The magnetic nanowires 361 to 364 is substantially linear, but may be slightly distorted (bent) as long as they are insulated without intersecting each other. The magnetic nanowires 361 and 364 are aligned substantially perpendicularly to the winding axis c (Z-axis) of the inductor 11, but may be slightly inclined relative to the vertical line of the winding axis c as long as they are insulated without intersecting each other. That is, the magnetic nanowires 361 and 364 may be inclined relative to the vertical line of the winding axis c (Z-axis) preferably within ±45 degrees, more preferably within ±30 degrees, and particularly preferably within ±15 degrees.

The magnetic nanowires 362 and 363 are aligned substantially in parallel to the winding axis c (Z-axis) of the inductor 11, but may be slightly inclined relative to the winding axis c (Z-axis) as long as they are insulated without intersecting each other. That is, the magnetic nanowires 362 and 363 may be inclined relative to the vertical line of the winding axis c (Z-axis) preferably within ±45 degrees, more preferably within 30 degrees, and particularly preferably within ±15 degrees. When the magnetic nanowires 361 to 364 are inclined at such an inclination angle, it is possible to impart high strength and permeability to the composite magnetic body.

The above-mentioned embodiments show application examples of the present invention to a low pass filter, but the present invention may be applied to other high-frequency electronic components, such as an inductor, a filter, or an antenna usable in a high-frequency region of megahertz band or gigahertz band. More specifically, the present invention may be applied to chip inductors, SAW filters, BAW filters, EMI filters, LTCCs, thin film filters, duplexers, band pass filters, baluns, diplexers, RF front ends, couplers, highly integrated modules for wireless connection and power management, or the like.

### EXAMPLES

Hereinafter, the present invention is described in more detail by way of specific examples, but the present invention is not limited to these examples.

### Example 1

### Preparation of High-Frequency Electronic Component 1

An Al foil was anodically oxidized in a 0.3 M oxalic acid solution at a voltage of 40V to prepare a periodic porous Al oxide having a thickness of 60 μm and a pore diameter of 100 nm. In an electrolyte composed of 1 M ferric sulfate, 0.7 M boric acid, and 1 mM sodium ascorbate maintained at 50 degrees with the cathode being an Al foil connected to the porous Al oxide and the anode being Fe, Fe magnetic nanowires 361 to 363 were electrodeposited in the pores of the periodic porous Al oxide by alternating current electrolysis at 500 Hz. The longitudinal length of the magnetic nanowires 361 to 363 was 21 μm, and the diameter of the magnetic nanowires 361 to 363 was 98 nm. The volume ratio of the magnetic nanowires 361 to 363 determined from the porosity of the periodic porous Al oxide as the insulators 365 to 367 was 51%. Thus, the composite magnetic body of Example 1 formed from the Fe magnetic nanowires 361 to 363 and the Al oxide insulators 365 to 367 was obtained.

When the composite magnetic body was used as the magnetic upper substrate 21, the magnetic lower substrate 22, and the magnetic central legs 23 and 24, a length L of the inductor 11 (an outer diameter of a wire of the coil portion 110 shown in FIG. 4) capable of obtaining a desired inductance was simulated. Then, based on the simulation results, the magnetic upper substrate 21, the magnetic lower substrate 22, and the magnetic central legs 23 and 24 were designed and manufactured.

The magnetic central legs 23 and 24 were formed such that the magnetic nanowires 361 were aligned substantially perpendicularly to the winding axis of the inductors 11 and 12. The magnetic upper substrate 21 and the magnetic lower substrate 22 were formed such that the magnetic nanowires 362 and 363 were aligned substantially in parallel to the winding axis of the inductors 11 and 12.

A vertical groove was dug from the surface using a Ga ion focused ion beam (FIB, FB-2100 manufactured by Hitachi, Ltd.), and the cross section was confirmed by observing the processed surface, that is, the cross-sectional SIM image at an observation angle of 45 degrees. Then, the direction of the magnetic nanowires 361 in the magnetic central legs 23 and 24 and the direction of the magnetic nanowires 362 and 363 in the magnetic upper substrate 21 and the magnetic lower substrate 22 were confirmed.

Further, a circuit pattern substrate was fabricated in which the inductors 11, 12, and 17 and the capacitors 13 to 16 shown in FIG. 1 were incorporated. For example, as shown in FIG. 4, the inductor 11 was manufactured by laminating a plurality of square ring-shaped conductor layers 311 and connecting them in a coil shape. Further, the inductor 12 was similarly manufactured. Although detailed illustration is omitted, the inductor 17 and the capacitors 13 to 16 were also manufactured by laminating a plurality of conductive layers and insulating layers. Then, these were integrated to manufacture a circuit pattern substrate in which the low-pass filter shown in FIG. 3 was built in.

Next, the circuit pattern substrate was placed on the upper surface of the magnetic lower substrate 22, and the magnetic central leg 23 was inserted into the opening 111 inside the coil portion 110 shown in FIG. 4 and was placed on the upper surface of the magnetic lower substrate 22. The magnetic central leg 24 was similarly placed on the upper surface of the magnetic lower substrate 22. Then, the magnetic upper substrate 21 covered the circuit pattern, and the respective parts were bonded with a resin to obtain the high-frequency electronic component 1.

### Evaluation

### <Magnetic Nanowire Shape, Composition, and Volume Ratio>

The cross section of the composite magnetic body was observed with a scanning electron microscope (SEM) (SU8000 manufactured by Hitachi High-Technologies Corporation) so as to measure the width and length of the magnetic nanowires 361 to 363, and the compositions of the magnetic nanowires 361 to 363 were measured with the attached EDX. The volume ratio of the magnetic nanowires 361 to 363 was determined from the weight of the unit area of the porous insulator, the weight of the magnetic nanowires after electrodeposition, and the specific gravity of the insulators 365 to 367 and the magnetic nanowires 361 to 363.

### <Real Part of Complex Permeability μ′ and Magnetic Loss tan δ/μ>

With a test piece processed into a rod shape of 1 mm×1 mm×80 mm, the real part of the complex permeability μ′ and the magnetic loss tan δ/μ of the composite magnetic body at 2.4 GHz were measured by the perturbation method using a network analyzer (manufactured by HP Agilent Technologies, HP8753D) and a cavity resonator (manufactured by Kanto Electronics Application Development Inc.)

### <Length L of Inductor and Insertion Loss IL of High-Frequency Electronic Component 1>

The insertion loss IL of the high-frequency electronic component 1 at 2.4 GHz was measured. Table 1 shows the real part of the complex permeability μ′ and the magnetic loss tan δ/μ of the composite magnetic body at 2.4 GHz, the length L of the inductors 11 and 12 (see FIG. 4), and the insertion loss IL of the high-frequency electronic component 1.

### Example 2

A composite magnetic body and a high-frequency electronic component 1 of Example 2 were produced in the same manner as in Example 1 except that the composite magnetic body was produced in the following manner using a method different from that of Example 1 and were subjected to a similar experiment.

After anodically oxidizing an Al foil in a 0.3 M perchloric acid solution at a voltage of 40 V, the Al foil and the anodic oxidation film in contact with the Al foil were dissolved in a sodium hydroxide solution to prepare a periodic porous Al oxide having a thickness of 70 μm and a pore diameter of 20 nm. An Al sputter deposited layer was formed on one surface of this periodic porous Al oxide to form a cathode. Using Co as an anode, the FeCo alloy magnetic nanowires 361 to 363 were DC electrodeposited into the pores of the periodic porous Al oxide in an electrolyte composed of 0.7 M ferric sulfate, 0.3 M cobalt sulfate, 0.7 M boric acid, and 1 mM sodium ascorbate maintained at 50 degrees. Thereafter, the Al sputter deposited layer was removed in a sodium hydroxide solution. Here, the diameter of the magnetic nanowires 361 to 363 was 19 nm, and the length of the magnetic nanowires 361 to 363 was 60 μm. As a result of composition evaluation by EDX, the composition of the magnetic nanowires 361 to 363 was 64% of Fe and 36% of Co. The volume ratio of the magnetic nanowires 361 to 363 determined from the porosity of the periodic porous Al oxide as the insulators 365 to 367 was 74%. Thus, a composite magnetic body of Example 2 formed from the FeCo alloy magnetic nanowires 361 to 363 and the Al oxide insulators 365 to 367 and the high-frequency electronic component 1 containing this composite magnetic body were obtained.

When the cross section was observed in the same manner as in Example 1, the direction of the magnetic nanowires 361 in the magnetic central legs 23 and 24 and the direction of the magnetic nanowires 362 and 363 in the magnetic upper substrate 21 and the magnetic lower substrate 22 were the same as that of Example 1.

### (Example 3

A composite magnetic body and a high-frequency electronic component 1 of Example 3 were produced in the same manner as in Example 1 except that the composite magnetic body was produced in the following manner using a method different from that of Example 1 and were subjected to a similar experiment.

A block copolymer composed of poly (ethylene oxide) methyl ether (molecular weight: 5000) as a hydrophilic block and a polymethacrylate having a polymerization degree of 50 to 150 as a hydrophobic block was synthesized by atom transfer radical polymerization method using copper complex as a catalyst. The obtained block copolymer was represented by the general formula (Formula 1).

CH₃(OCH₂CH₂)ₘO—CO—C(CH₃)₂—(C(CH₃COOR))ₙ [Formula 1]

Here, m is 80 to 120, n is 50 to 80, and R is an alkyl group.

The obtained 0.02 g block copolymer was mixed with a 0.01 g polyethylene oxide (molecular weight: 400, polymerization degree: 7) and dissolved in chloroform to obtain a 10 wt % solution. This solution was bar-coated on an aluminum foil ultrasonically cleaned with isopropanol so as to have a thickness of 1 μm. Then, a heat treatment was performed at 140° C. for 1 hour, and the hydrophilic block was removed in 0.3 M phosphoric acid-disodium hydrogen phosphate aqueous solution of pH 6.9 to form a periodic porous copolymer film having a thickness of 1 μm and a pore diameter of 10 nm on the Al foil.

Using Co as the anode, the FeCo alloy magnetic nanowires 361 to 363 were DC electrodeposited into the pores of the periodic porous copolymer film in an electrolyte composed of 0.7 M ferric sulfate, 0.3 M cobalt sulfate, 0.7 M boric acid, and 1 nM sodium ascorbate maintained at 50 degrees. Thereafter, the Al foil was removed in a sodium hydroxide solution. Here, the diameter of the magnetic nanowires 361 to 363 was 10 nm, and the length of the magnetic nanowires 361 to 363 was 1 μm. As a result of composition evaluation by EDX, the composition of the magnetic nanowires 361 to 363 was 64% of Fe and 36% of Co. The volume ratio of the magnetic nanowires 361 to 363 determined from the porosity of the periodic porous copolymer film as the insulators was 74%. Thus, a composite magnetic body of Example 3 composed of the FeCo alloy magnetic nanowires 361 to 363 and the periodic porous copolymer film insulators and the high-frequency electronic component 1 containing this composite magnetic body were obtained.

Here, the magnetic central legs 23 and 24 were formed such that the magnetic nanowires 361 were aligned substantially perpendicularly to the winding axis of the inductor 11. The magnetic upper substrate 21 and the magnetic lower substrate 22 were formed such that the magnetic nanowires 362 and 363 were aligned substantially in parallel to the winding axis of the inductor 11.

### Example 4

A composite magnetic body and a high-frequency electronic component 1 of Example 4 were produced in the same manner as in Example 1 except that the composite magnetic body was produced in the following manner using a method different from that of Example 1 and were subjected to a similar experiment.

Insulating layers 341 and 342 were formed on the magnetic lower substrate 22 of Example 1, the coil portions 110 and 120 were formed, and the magnetic central legs 23 and 24 were formed as follows.

That is, a FeCo layer having a thickness of 20 nm was formed by sputtering, a resist ink was printed with a resin mold having a line/space of 20 nm/20 nm, the FeCo layer not printed with the resist ink by reactive ion etching (RIE) was removed, and a 10 nm alumina layer was sputter deposited thereon. This process was repeated to form the magnetic core legs 23 and 24. Thereafter, the magnetic upper substrate 21 covered the magnetic core legs 23 and 24, and the respective parts were bonded with a resin to obtain a composite magnetic body of Example 4 and the high-frequency electronic component 1 containing this composite magnetic body.

When the cross section was observed in the same manner as in Example 1, the direction of the magnetic nanowires 361 in the magnetic central legs 23 and 24 and the direction of the magnetic nanowires 362 and 363 in the magnetic upper substrate 21 and the magnetic lower substrate 22 were the same as that of Example 1.

### Example 5

A composite magnetic body and a high-frequency electronic component 1 of Example 5 were produced in the same manner as in Example 1 except that the composite magnetic body was produced in the following manner using a method different from that of Example 1 and were subjected to a similar experiment.

Nanowires of FeCo alloy were formed on an yttria-stabilized zirconia (YSZ) substrate by CVD using iron chloride and cobalt chloride as evaporation sources and nitrogen gas containing 4% hydrogen as a carrier. The nanowires were taken out and weighed so that the ratio of polyethylene resin was 30 vol %:70 vol %. The above materials were appropriately added with a dispersant and a coupling agent and were kneaded using a mixing roll (No. 191-TM/WM) manufactured by YASUDA SEIKI SEISAKUSHO, LID. The kneading was performed while heating the raw materials to 140° C. until needle-like magnetic particles were homogeneously mixed in the polyethylene resin. Next, the nanowires were aligned by applying a magnetic field to the obtained raw material mixture. Further, this was introduced into a mold heated to 180° C. and molded at a pressure of 35 MPa. Thus, a composite magnetic body of Example 5 and a high-frequency electronic component 1 containing this composite magnetic body were obtained.

When the cross section was observed in the same manner as in Example 1, the direction of the magnetic nanowires 361 in the magnetic central legs 23 and 24 and the direction of the magnetic nanowires 362 and 363 in the magnetic upper substrate 21 and the magnetic lower substrate 22 were the same as that of Example 1.

### Example 6

Except that the direction of the magnetic nanowires 361 in the magnetic central legs 23 and 24 and the direction of the magnetic nanowires 362 and 363 in the magnetic upper substrate 21 and the magnetic lower substrate 22 were reversed from those in Example 5, a composite magnetic body and a high-frequency electronic component 1 of Example 6 were produced in the same manner as in Example 5 and were subjected to a similar experiment. Table 1 shows the results.

### Comparative Example 1

A composite magnetic body and a high-frequency electronic component 1 of Comparative Example 1 were produced in the same manner as in Example 1 except that the composite magnetic body was produced as follows by a method different from that of Example 1 and were subjected to a similar experiment.

Using iron oxide (Fe₂O₃) 73 mol %, cobalt oxide (Co₃O₄) 18 mo1 %, and barium carbonate (BaCO₃) 9 mol % as raw materials, they were weighed so as to have a predetermined composition. Then, the weighed raw materials were blended in a wet ball mill using water as a medium for 16 hours and were thereafter fired at 1250° C. in the air. The magnetic oxide thereby obtained was subjected to dry pulverization for 10 minutes in a vibration mill and was thereafter pulverized in a wet ball mill using water as a medium for 88 hours. Then, the pulverized magnetic oxide was dried at 150° C. for 24 hours to obtain a powder of the magnetic oxide (magnetic oxide powder W) having an average particle size of 1 μm or less. This magnetic oxide had a main component of Co-substituted W-type hexagonal ferrite (BaCo₂Fe₁₆O₂₇). Thus, a composite magnetic body of Comparative Example 1 and a high-frequency electronic component 1 containing the composite magnetic body were obtained.

Incidentally, the composite magnetic body of Comparative Example 1 was ferrite and used no nanowires. In Table 1, the columns of the direction of the nanowires were thereby represented as “-”.

### Comparative Example 2

A composite magnetic body and a high-frequency electronic component 1 of Comparative Example 2 were produced in the same manner as in Example 1 except that the composite magnetic body was produced as follows by a method different from that of Example 1 and were subjected to a similar experiment.

Fe₇₀Co₃₀ alloy needle-like particles with a major axis length of 45 nm and an aspect ratio of 1.5 and a polyethylene resin as a dielectric material were weighed so that the ratio of the needle-like magnetic particles and the polyethylene resin was 30 vol % 70 vol %. The above materials were appropriately added with a dispersant and a coupling agent and were kneaded using a mixing roll (No. 191-TM/WM) manufactured by YASUDA SEIKI SEISAKUSHO, LTD. The kneading was performed while heating the raw materials to 140° C. until the needle-like magnetic particles were homogeneously mixed in the polyethylene resin. Next, the obtained raw material mixture was introduced into a mold heated to 180° C. and molded at a pressure of 35 MPa. Thus, a composite magnetic body of Comparative Example 2 and a high-frequency electronic component 1 containing this composite magnetic body were obtained.

When the cross section was observed in the same mariner as in Example 1, the direction of the magnetic nanowires 361 in the magnetic central legs 23 and 24 and the direction of the magnetic nanowires 362 and 363 in the magnetic upper substrate 21 and the magnetic lower substrate 22 were random.

TABLE 1

| | | | Direction of magnetic | | | |
|---|---|---|---|---|---|---|
| | | | nanowires contained in | Direction of magnetic | | |
| | | | magnetic upper and | nanowires contained in | | |
| | | | lower substrates to | magnetic central leg to | | |
| | μ′ | tan δ/μ | winding axis of coil | winding axis of coil | L(μm) | IL(dB) |
| Ex. 1 | 2.5 | 0.015 | substantially parallel | substantially perpendicular | 1958 | 0.85 |
| Ex. 2 | 2.8 | 0.018 | substantially parallel | substantially perpendicular | 1893 | 0.81 |
| Ex. 3 | 2.8 | 0.018 | substantially parallel | substantially perpendicular | 1932 | 0.88 |
| Ex. 4 | 2.7 | 0.017 | substantially parallel | substantially perpendicular | 1914 | 0.82 |
| Ex. 5 | 2.6 | 0.022 | substantially parallel | substantially perpendicular | 1978 | 0.89 |
| Ex. 6 | 2.3 | 0.024 | substantially perpendicular | substantially parallel | 2112 | 0.95 |
| Comp. Ex. 1 | 1.4 | 0.041 | — | — | 2572 | 1.09 |
| Comp. Ex. 2 | 2.0 | 0.098 | random | random | 2156 | 1.28 |

As shown in Table 1, in Examples 1 to 6, the real part of the complex permeability μ′ at 2.4 GHz was 2.3 or more, preferably 2.5 or more, and the magnetic loss tan δ/μ was 0.024 or less, preferably 0.022 or less. On the other hand, in Comparative Examples 1 and 2, the real part of the complex permeability μ′ at 2.4 GHz was 2.0 or less, and the magnetic loss tan δ/μ was 0.041 or more. That is, the composite magnetic body according to the present example had a high real part of complex permeability μ′ and a low magnetic loss tan δ/μ in the gigahertz band.

Further, in Examples 1 to 6, the length L of the inductors 11 and 12 was 2150 μm or less, and the insertion loss IL of the high-frequency electronic component 1 was less than 1.00 dB (0.95 dB or less). On the other hand, in Comparative Examples 1 and 2, the length L of the inductors 11 and 12 was larger than 2150 μm, and the insertion loss IL of the high-frequency electronic component 1 was 1.00 dB or more (1.09 dB or more). That is, in the high-frequency electronic component 1 including the composite magnetic body according to the present example, the length L of the inductors 11 and 12 can be reduced, and it is thereby possible to miniaturize the high-frequency electronic component 1 itself and to obtain the high-frequency electronic component 1 having excellent characteristics with a small insertion loss IL. Comparing Examples 1 to 5 with Example 6, it is confirmed that Examples 1 to 5 were more excellent than Example 6 in all items of μ′, tan δ/μ, length L, and IL.

### DESCRIPTION OF THE REFERENCE NUMERICAL

1, 1A . . . high-frequency electronic component
11, 12, 17 . . . inductor
110, 120 . . . coil portion
111, 121 . . . opening
13, 14, 15, 16 . . . capacitor
21 . . . magnetic upper substrate
22 . . . magnetic lower substrate
23, 24 . . . magnetic central leg
25, 26 . . . magnetic outer leg
311, 312, 316 . . . conductor layer
341, 342, 336 . . . insulating layer
361, 362, 363, 364 . . . magnetic nanowire
365, 366, 367, 368 . . . insulator

1-9. (canceled)

10. A composite magnetic body comprising:
magnetic nanowires aligned so as not to intersect each other; and
an insulator for electrically insulating the magnetic nanowires.

11. The composite magnetic body according to claim 10, wherein the magnetic nanowires contain at least one metal of Fe, Co, and Ni.

12. A substrate comprising the composite magnetic body according to claim 10.

13. A high-frequency electronic component comprising the composite magnetic body according to claim 10.

14. A high-frequency electronic component comprising the substrate according to claim 12.

15. The high-frequency electronic component according to claim 13, wherein the composite magnetic body is contained in a magnetic core.

16. The high-frequency electronic component according to claim 14, wherein the composite magnetic body is contained in a magnetic core.

17. The high-frequency electronic component according to claim 15, wherein
the magnetic core includes a magnetic central leg passing through a coil, and
the magnetic nanowires contained in the magnetic central leg are aligned substantially perpendicularly to a winding axis of the coil.

18. The high-frequency electronic component according to claim 16, wherein
the magnetic core includes a magnetic central leg passing through a coil, and
the magnetic nanowires contained in the magnetic central leg are aligned substantially perpendicularly to a winding axis of the coil.

19. The high-frequency electronic component according to claim 15, wherein
the substrate includes at least one of a magnetic upper substrate disposed above the coil and a magnetic lower substrate disposed below the coil, and
the magnetic nanowires contained in at least one of the magnetic upper substrate and the magnetic lower substrate are aligned substantially in parallel to the winding axis of the coil.

20. The high-frequency electronic component according to claim 16, wherein
the substrate includes at least one of a magnetic upper substrate disposed above the coil and a magnetic lower substrate disposed below the coil, and
the magnetic nanowires contained in at least one of the magnetic upper substrate and the magnetic lower substrate are aligned substantially in parallel to the winding axis of the coil.

21. The high-frequency electronic component according to claim 17, wherein
the substrate includes at least one of a magnetic upper substrate disposed above the coil and a magnetic lower substrate disposed below the coil, and
the magnetic nanowires contained in at least one of the magnetic upper substrate and the magnetic lower substrate are aligned substantially in parallel to the winding axis of the coil.

22. The high-frequency electronic component according to claim 18, wherein
the substrate includes at least one of a magnetic upper substrate disposed above the coil and a magnetic lower substrate disposed below the coil, and
the magnetic nanowires contained in at least one of the magnetic upper substrate and the magnetic lower substrate are aligned substantially in parallel to the winding axis of the coil.

23. The high-frequency electronic component according to claim 15, wherein
the magnetic core includes a magnetic outer leg disposed at a periphery of the coil, and
the magnetic nanowires contained in the magnetic outer leg are aligned substantially perpendicularly to the winding axis of the coil.

24. The high-frequency electronic component according to claim 17, wherein
the magnetic core includes a magnetic outer leg disposed at a periphery of the coil, and
the magnetic nanowires contained in the magnetic outer leg are aligned substantially perpendicularly to the winding axis of the coil.

25. The high-frequency electronic component according to claim 19, wherein
the magnetic core includes a magnetic outer leg disposed at a periphery of the coil, and
the magnetic nanowires contained in the magnetic outer leg are aligned substantially perpendicularly to the winding axis of the coil.
